(19) United States
(12) Patent Application Publication
(10) Pub. No.: US 2006/0239018 A1
(43) Pub. Date: Oct. 26, 2006

(54) Display system using wheel-mounted strips of flashing lights

(75) Inventor: James A. Jardin, Vista, CA (US)

Correspondence Address: Directed Electronics, One Viper Way, Vista, CA, 92081, US

(73) Assignees: DEI HEADQUARTERS, INC.; Directed Electronics, Inc., Vista, CA (US)

(21) Appl. No.: 11/112,885

(22) Filed: Apr. 22, 2005

(51) Int. Cl. B60Q 1/00

(52) U.S. Cl. 362/459

(57) ABSTRACT

A strip with multiple LEDs is installed on a wheel. When the wheel rotates, the LEDs are activated by a controller in accordance with stored image files, displaying the images. The LEDs may be multi-color devices, displaying the images in multiple colors. The image files may be downloaded over a wired or wireless connection. The controller monitors a sensor to determine angular positions of the LEDs in real time. The controller may vary the images in predetermined ways, or in response to commands received wirelessly from a control device. The LEDs may be powered by a generator driven by acceleration of the wheel, or by air movement in relation to the wheel. Multiple LED strips may be installed on a wheel to improve image appearance. Multiple wheels of the same vehicle may be equipped with LED strips. The images displayed on the wheels may be coordinated over a wireless interface.

### FIELD OF THE INVENTION

The present invention relates generally to automotive display and lighting systems, and more particularly, to customizable display and lighting systems for automotive wheel assemblies.

### BACKGROUND

To many people, automobile is much more than a mere conveyance. It is an extension of one's ego and means of self-expression. We adorn the automobile with rear wings, skirts and other bodywork. We give it custom exhaust tips, special mufflers to change the sound of its engine, and vanity plates. For the most part, these and many other automotive accessories have little if any functional effect. They are usually added for the simple purpose of personalizing the automobile. Automobiles and trucks have also been used as rolling billboards to display commercial messages.

Of all externally visible automobile components, perhaps the most tender loving care has been lavished on automobile wheels. From chrome rims to ultra-low-profile tires to custom hubcaps, these and other wheel assembly components have received more than their fair share of designer attention from both original equipment manufacturers and after market suppliers and installers.

Automobile owners have been known to have several wheel and tire sets for the same automobile. One justification for multiple wheel and tire sets is the need for snow tires. Another justification, and more to the point in the present context, is to change vehicle appearance for different occasions. Wheel mounting and dismounting, however, are unpleasant, time-consuming tasks requiring lifting the automobile. They are best performed in a garage or a service station. Dismounted wheel and tire sets also need to be stored somewhere. Thus, maintaining multiple wheel and tire sets is inconvenient and does not allow quick wheel replacement to change automobile appearance.

Automobile wheels may not be clearly visible at night. Any personalization or appearance change of the wheels may therefore not be noticed by observers.

Text messages and many graphics on automobile wheels blur when the automobile is moving, because of the wheels' rotation. This effect also prevents the observers from noticing the personalized wheel appearance when the automobile is in motion.

It would be desirable to enable vehicle owners to change wheel appearance quickly and easily, and to make the wheels more readily noticeable in the dark and when the automobile is being driven.

### SUMMARY

A need thus exists for wheels with appearance that can be changed easily and quickly. Another need exists for wheels that can be used to display messages, and particularly messages that can be seen and read at night and while the vehicle is moving. Still another need exists for wheels with customizable displays that do not require excessive maintenance, such as battery replacement. An additional need exists for wheels capable of displaying text and graphics throughout a range of vehicle speeds.

Embodiments of the present invention are directed to methods, apparatus, and articles of manufacture that satisfy one or more of these needs. In some aspects, the invention herein disclosed is a display apparatus that includes a plurality of light sources, such as light emitting diodes (LEDs) positioned at varying distances from center of rotation of a wheel assembly, e.g., positioned along one or more radial directions of the wheel assembly, an angular position sensor that provides a signal that varies with rotation of the wheel assembly, and a control module coupled to the plurality of light sources and to the angular position sensor.

The control module includes a processor configured to receive the signal provided by the angular position sensor, determine angular position of the rotating wheel assembly from the signal provided by the angular position sensor, determine angular velocity of the rotating wheel assembly, compute ON and OFF times for each light source of the plurality of light sources so as to create appearance of an image when the light sources are turned on during ON times and turned off during OFF times, and turn the light sources on and off during the ON and OFF times, respectively.

In accordance with selected aspects of the invention, the signal provided by the angular position sensor indicates gravitational and centrifugal force acting on an element of the angular position sensor that is attached to the wheel assembly and rotating with the wheel assembly.

In accordance with selected aspects of the invention, the angular position sensor includes a magnet mounted on a wheel well and a magnetic pick-up coil mounted on the wheel assembly. The signal provided by the angular position sensor is output by the magnetic pick-up coil as the coil is moved in proximity of the wheel well-mounted magnet by the rotation of the wheel assembly.

In accordance with selected aspects of the invention, the processor determines the angular velocity by determining a time period between sequential points in time when the rotating wheel assembly is in a predetermined angular position, and dividing the time period by the number of revolutions of the rotating wheel assembly during the time period.

In accordance with selected aspects of the invention, each LED of at least a subset of the plurality of LEDs is a multi-color LED, and the processor computes ON and OFF times for each color of each multi-color LED of the subset. The processor may also compute intensity values for the multi-color LEDs, and drive the LEDs with drive levels corresponding to the intensity values of each color of each LED at each point in time when the LEDs are on.

In accordance with selected aspects of the invention, the display apparatus is self-powered. For example, the display apparatus may also include a generator capable of generating electrical energy for operation of the plurality of light sources from kinetic energy of the wheel assembly. As another example of self-powered display apparatus, the apparatus may also include a generator capable of generating electrical energy for operation of the plurality of light sources from movement of surrounding air in relation to the wheel assembly.

In accordance with selected aspects of the invention, the display apparatus also includes a wireless communication module, and the processor is further configured to receive through the wireless communication module a command to display the image, and to turn the light sources on during the ON times and off during the OFF times in response to receipt of the command. The display apparatus may also include a remote control device capable of sending the command over a wireless communication channel. The command may include a selection (indication) of the image from a plurality of images, and the processor is further configured to identify the image from the selection included in the command.

In accordance with selected aspects of the invention, the processor is further configured to receive over the wireless communication module an image file corresponding to the image, and to compute the ON and OFF times in accordance with the image file, i.e., compute the ON and OFF times from data in the image file, the angular position of the wheel assembly, and the angular velocity of the wheel assembly.

In accordance with selected aspects of the invention, the light sources of the plurality of light sources are built-into a hubcap or a rim of the wheel assembly.

In accordance with selected aspects of the invention, the display apparatus also includes a body with a first end and a second end. An aperture capable of receiving a wheel mounting bolt of the wheel assembly is formed on the first end of the body, and an opening capable of receiving an air valve stem of the wheel assembly is formed on the second end of the body. The opening and the aperture are positioned so that the body can be mounted on the wheel assembly with the wheel mounting bolt protruding through the aperture, and the opening receiving the air valve stem. The light sources of the plurality of light sources are distributed along a length of the body between the first and the second ends.

These and other features and aspects of the present invention will be better understood with reference to the following description, drawings, and appended claims.

### BRIEF DESCRIPTION OF THE FIGURES

FIG. 1 illustrates selected components of a light display bar capable of displaying images when the bar is mounted on a rotating wheel, in accordance with some aspects of the present invention;

FIG. 2 illustrates the light display bar of FIG. 1 mounted on a wheel assembly of a vehicle, in accordance with some aspects of the present invention;

FIG. 3 illustrates selected electronic interconnections of the light display bar of FIG. 1, in accordance with some aspects of the present invention;

FIG. 4 illustrates the rotating wheel assembly of FIG. 2 with the light display bar of FIG. 1 displaying a stationary text message, in accordance with some aspects of the present invention; and

FIG. 5 illustrates selected steps of a method for displaying an image on a rotating object, in accordance with some aspects of the present invention.

### DETAILED DESCRIPTION

In this document, the words “embodiment” and “variant,” as well as similar expressions, refer to particular apparatus, process, or article of manufacture, and not necessarily to the same apparatus, process, or article of manufacture. Thus, “one embodiment” or a similar expression used in one place or context may refer to a particular apparatus, process, or article of manufacture; the same or a similar expression in a different place may refer to the same or a different apparatus, process, or article of manufacture. Similarly, “some embodiments,” “certain embodiments,” or similar expressions used in one place or context may refer to one or more particular apparatus, process, or article of manufacture; the same or similar expressions in a different place or context may refer to the same or a different apparatus, process, or article of manufacture. The expressions “alternative embodiment,” “alternatively,” and similar phrases may be used to indicate one of a number of different possible embodiments. The number of possible embodiments is not necessarily limited to two or any other quantity. The words “couple,” “connect,” and similar expressions with their inflectional morphemes do not necessarily import an immediate or direct connection, but include connections through mediate elements within their meaning. The expression “radio frequency” and its abbreviation “RF” are used to describe the portion of the electromagnetic spectrum that includes microwaves, extending from about 10 KHz to about 300 GHz. The expression “light source” applies to a source of visible radiation or color, such as a light emitting diode (LED), laser, neon lamp, or generator of electro-luminescence. Other definitions may be found elsewhere in this document. The definitions are intended to assist in understanding this disclosure and the appended claims, but the scope and spirit of the invention should not be construed as strictly limited to these definitions, or to the particular examples described in this specification.

Reference will now be made in detail to several embodiments of the invention that are illustrated in the accompanying drawings. Same or similar reference numerals may be used in the drawings and the description to refer to the same or like apparatus elements and method steps. The drawings are in simplified form, not to scale, and omit apparatus elements and method steps that can be added to the described systems and methods, while including certain optional elements and steps.

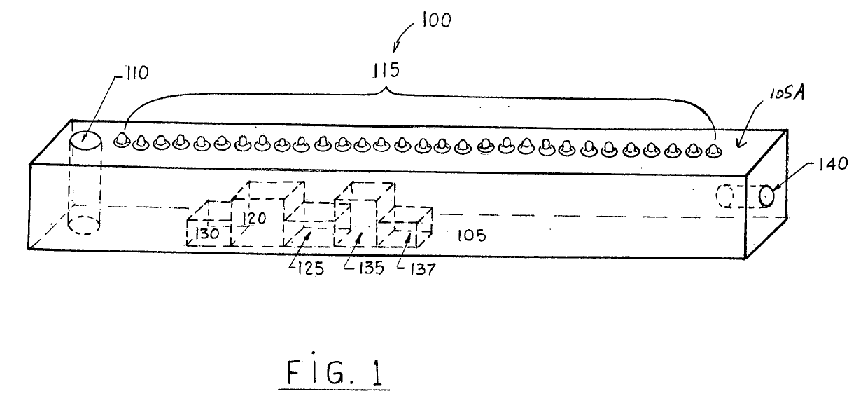

FIG. 1 illustrates selected elements of a light display bar 100 in accordance with aspects of the present invention. The light display bar 100 includes a body 105, an array of light sources 115, a control module 120, a communication module 125, an angular position sensor 130, a power module 135, and an activation switch 137. Some of these components are shown in dashed lines to indicate that these components are inside the body 105. This is not necessarily a requirement of the invention.

The body 105 is designed for mounting on a wheel of an automobile. To facilitate such mounting, the body 105 includes portions defining a circular aperture 110 and an opening 140. The aperture 110 is located proximate one end of the body 105 of the light display bar 100, and extends through the body 105. The diameter of the aperture 110 is sufficient to accommodate an automotive wheel mounting bolt. In variants of the embodiment 100, the diameter of the aperture 110 is such that the aperture 110 snuggly accepts a wheel mounting bolt for a specific automobile and does not allow significant play of the bolt within the aperture 110. For example, the diameter may be wider than the outer perimeter of the bolt by about 1/32th of an inch. In some embodiments, top surface 105A of the body 105 is indented proximate to the aperture 110 so as to accept and retain a wheel mounting lug nut that screws onto the wheel mounting bolt.

The opening 140 is located on the end of the body 105 that is opposite the end with the aperture 110. The opening 140 is designed and sized to receive snuggly a tire (air) valve stem of an automotive wheel. As illustrated in FIG. 1, the opening 140 is substantially circular and extends axially within the body 105. In some embodiments, the opening extends at an angle to the center axis of the body 105.

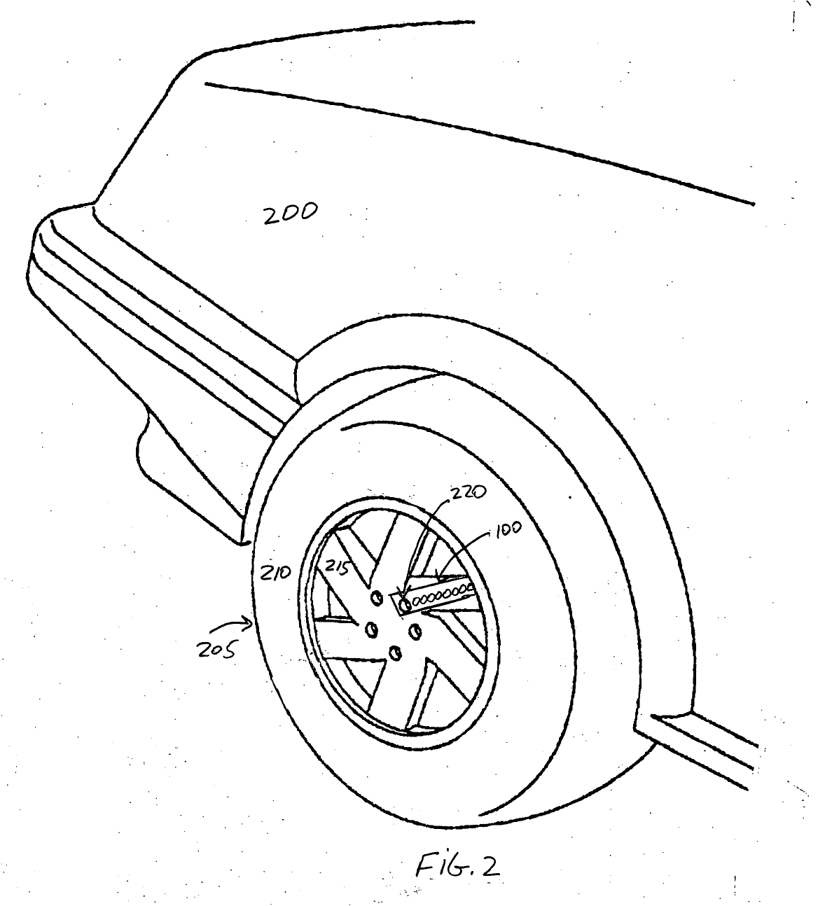

To help understand mounting of the light display bar 100, FIG. 2 illustrates the light display bar 100 mounted on a wheel assembly 205 of a vehicle 200. The light display bar 100 is disposed radially on a rim 215 of the wheel assembly 205 between one of the wheel mounting bolts and a tire (air) valve stem of the wheel assembly 205. In this position, the opening 140 of the body 105 receives the tire valve stem of the wheel assembly 205, while a wheel mounting bolt 220 of the wheel assembly 205 protrudes through the aperture 110. A lug nut is screwed onto the wheel mounting bolt 220, keeping the light display bar 100 in position on the wheel assembly 205.

In the illustrated embodiment 100, each light source of the array 115 is a light emitting diode. In variants of this embodiment, each light source 115 is a single-color light emitting diode, for example, a red light emitting diode.

In other variants of the embodiment 100, light sources 115 include multi-color light emitting diodes, for example, tri-color light emitting diodes. A tri-color light emitting diode is a device that includes three substantially monochromatic (single color) constituent light emitting diodes. The tri-color device may further include a lens assembly. Each of the constituent monochromatic diodes is connected to and receives driving current from a separate input. The light emitted by each of the constituent diodes of the tri-color diode passes through the lens assembly, which converges (i.e., aligns or combines) the three different colors at some focal point. In this way, the emissions of the three constituent monochromatic diodes can mix together and appear as light of one color to an observer's eye. A person skilled in the art of color generation and display can produce practically any color by mixing the red, green, and blue light emissions (or other primary color emissions) in varying intensities. Appropriate modulation (intensities) of the three diodes can thus cause the tri-color device to produce a multitude of different colors. See, for example, Muthu et al., U.S. Pat. No. 6,441,558; Mueller et al., U.S. Pat. No. 6,016,038; Mueller et al., U.S. Pat. No. 6,150,774; Lys et al., U.S. Pat. No. 6,166,496; Lys et al., U.S. Pat. No. 6,211,626; Lys et al., U.S. Pat. No. 6,292,901; Lys et al., U.S. Pat. No. 6,340,868; Lys et al., U.S. Pat. No. 6,459,919; Lys et al., U.S. Pat. No. 6,528,954; Dowling et al., U.S. Pat. No. 6,548,967; and Lys et al., U.S. Patent Publication Number 2002/0113555 (application Ser. No. 09/742,017, Aug. 22, 2002). These documents are hereby incorporated by reference as if fully set forth herein, including all figures, tables, and claims.

Non-primary colors and fewer than three colors may also be employed in certain embodiments.

The power module 135 provides electrical power for operation of the light display bar 100, including operation of the light sources 115, control module 120, communication module 125, and angular position sensor 130. In some embodiments, the power module 135 includes one or more electrical energy storage cells, such as primary (non-rechargeable) chemical cells, secondary (rechargeable) chemical cells, and fuel cells.

In some embodiments, the light display bar 100 is self-powered. Self-powered in this context means that the power module 135 generates renewable electrical energy from rotation of the wheel assembly 205. The power module 135 of a self-powered bar 100 may include, for example, a generator capable of producing electrical energy from kinetic energy, e.g., kinetic energy resulting from acceleration and deceleration of the wheel assembly 205 and the light display bar 100 attached to it. The kinetic energy may be harnessed by a device similar to a watch self-winding mechanisms. In some embodiments, the power module 135 includes a generator driven by air movement in relation to the light display bar 100. An interested reader may find examples of wheel-mounted electrical power generators in Cheng, U.S. Pat. No. 6,386,731; and in Chien, U.S. Patent Publication Number 2002/0172036 (application Ser. No. 09/859,435). These documents are hereby incorporated by reference as if fully set forth herein, including all figures, tables, and claims.

In some embodiments, the power module 135 includes a combination of energy storage devices, such as rechargeable cells, and an electric energy generator.

The activation switch 137 detects rotation of the wheel assembly 205 and activates the light display bar 100. In some embodiments, the activation switch 137 is implemented as a centrifugal switch. In some embodiments, the switch 137 is combined with the angular position sensor 130.

The communication module 125 includes a receiver capable of receiving information and commands from a remote control device. In some embodiments, the communication module 125 and the remote control device communicate wirelessly, for example, via an RF link. Short-distance communication standards, such as Bluetooth, are particularly suitable for the RF link. The remote control device, which is not shown in the Figures, may be installed in the passenger compartment of the automobile 200, for example, on or proximate to a dashboard. In some embodiments, the remote control module also incorporates a key-fob for attaching keys of the automobile 200. In some embodiments, the remote control device is also capable of controlling and/or programming a security system installed in the automobile 200.

The wireless communications between the communication module 125 and the remote control device may also take place over the infrared portion of the electromagnetic spectrum, using infrared receivers and transmitters. Moreover, the communications need not be wireless. In some embodiments, the communications module 125 includes a receptacle for a plug-in connection from an external programming device. Data may be downloaded into the control module 125 from the external programming device. The data received by the control module 125 from the external programming device, the remote control device, or another device may include patterns to be displayed using the light sources of the array 115.

The communication module 125 may also include a transmitter capable of transmitting data to the remote control device. In some embodiments, the transmitted data includes self-diagnostic information generated by the control module 120. In some embodiments, the light display bar 100 includes an air pressure sensor and a coupler for connecting the air pressure sensor to the tire valve stem of the wheel assembly 205. The air pressure sensor reads the air pressure in a tire 210 that is mounted on the rim 215, and sends the readings through the communication module 125 to a remote control device, allowing remote monitoring of the tire pressure.

The angular position sensor 130 includes a device that can be used to determine the relative angular position of the wheel 210. In one embodiment, the angular position sensor 130 includes a force sensor that can measure a force exerted by a known mass. For example, the sensor may include a mass element movable in one dimension against a bias provided by a spring or similar bias means. The sensor determines the force exerted by the mass element from the deviation of the mass element from its center position. The dimension in which the mass element can move is substantially coincident with a radial extending from the center of the wheel assembly 205 to the periphery of the wheel assembly 205. As illustrated in FIG. 2, the dimension would be substantially along the center axis of the body 105 of the light display bar 100.

When the wheel assembly 205 rotates, the total force exerted by the mass element is a vector sum of two separate forces: (1) the mass element's weight, and (2) the centrifugal force resulting from the rotation of the wheel assembly 205. The two forces add constructively when the light display bar 100 is in a vertical position with the aperture 110 (which receives the wheel mounting bolt) being above the opening 140 (which receives the tire valve stem). The two forces add destructively when the light display bar 100 is in a vertical position and the opening 140 is above the aperture 110. From the force indicated by the sensor 130, it is possible to determine the vertical positions of the wheel assembly 205. Signal processing, such as averaging, may be applied to the signal output by the sensor 130. As will be discussed below, the control module 120 performs the signal processing and the ultimate determination of the time of the vertical positions of the wheel assembly 205.

In another embodiment, the angular position sensor 130 includes a magnet installed in a wheel well of the wheel assembly 205 and a magnetic pick-up coil on one end of the bar 100. The magnetic pick-up coil generates a voltage spike when the wheel assembly 205 moves the magnetic pick-up coil of the bar 100 by the wheel well-mounted magnet.

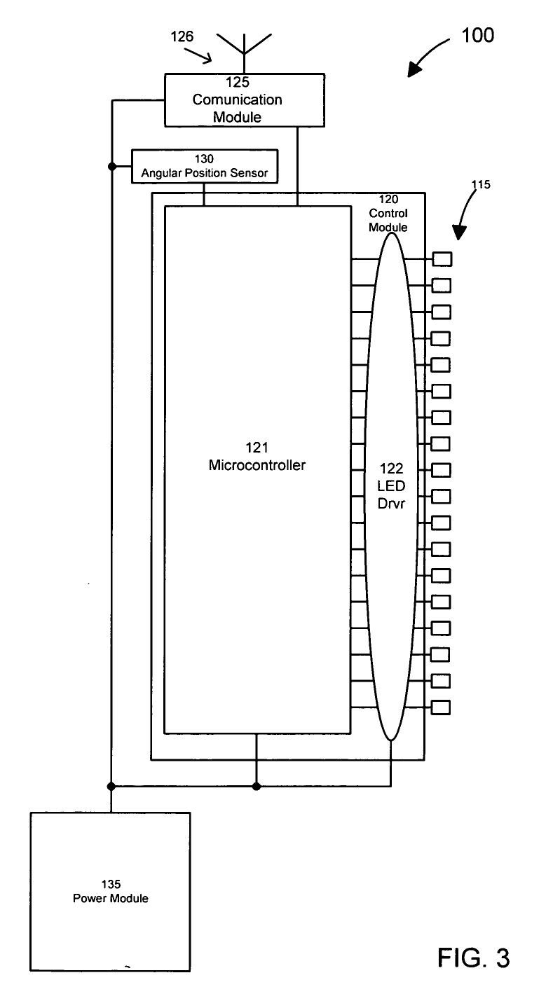

The control module 120 may be based on a digital microprocessor, microcontroller, an application-specific circuit, or a collection of circuits. Operation of the control module 120 is described with reference to FIG. 3, which illustrates selected electronic interconnections of an embodiment of the light display bar 100. In FIG. 3, the control module 120 is shown as a combination of a microcontroller 121 and an LED driver 122. The microcontroller 121 includes (1) a processing unit, (2) read only memory (ROM) storing program code and data, (3) random access memory (RAM) for use as operating registers, address registers, and for other data storage during program execution, and (4) various input-output (I/O) circuits, including interfaces to the LED driver 122, the communication module 125, and the angular position sensor 130. The microcontroller 121 may also include programmable (re-writable) memory, for example, electrically programmable read only memory (EPROM), erasable electrically programmable read only memory (EEPROM), and flash memory. In some embodiments, the control module 120 includes such re-writable memory as a separate (external) element connected to the microcontroller 121. The microcontroller 121 can write data into and read the data from the re-writable memory, whether internal or external.

Data defining images and patterns to be displayed by the light display bar 100 may be stored in the internal memory of the microcontroller 121 or in a memory external to the microcontroller 121, for example, in a ROM or a re-writable memory (EEPROM, flash, or a similar device). In some embodiments, the microcontroller 121 receives the image or pattern data from a remote control device or from an external programming device. In some embodiments, the image data can be downloaded to the memory from a computing device, such as a personal computer (laptop or desktop) or a PDA, through an interface, for example, a serial interface. In some embodiments, the image or pattern data is preprogrammed at a factory or a distribution facility at the time of manufacture or sale. In some embodiments, the image or pattern data can be downloaded through the communication module 125.

The LED driver 122 receives input from LED interface of the microcontroller 121 and turns the individual light sources (LEDs) 115 on and off. In some embodiments, the LED interface of the microcontroller may be able to drive the LEDs (or other light sources) 115 directly, without the driver 122. In these embodiments, there is no need to interpose the driver 122 between the LEDs 115 and the microcontroller 121.

The microcontroller 121 and the LED driver 122 may also modulate the inputs of the LEDs 115 (i.e., vary the drive of each input to cause different light intensities), particularly in case of multi-color LEDs.

In operation, the microcontroller 121 receives through the communication module 125 a command to display a particular image using the LEDs 115. The command may simply direct the microcontroller 121 to display an image or a pattern. The command may also specify a particular image/pattern or sequence of images or patterns to be displayed.

When the wheel assembly 205 rotates, as detected by the activation switch 137, the angular position sensor 130 sends to the microcontroller 121 a signal from which the microcontroller 121 computes the relative angular position of the wheel assembly 205 and the light display bar 100. For example, the sensor 130 may send to the microcontroller 121 a voltage related to the pressure exerted by an object movable in the radial direction under influence of the centrifugal and gravitational forces. From this voltage signal, the microcontroller 121 determines the times when the light display bar 100 is in the vertical positions pointing up and down, as has been described above. The microcontroller 121 then estimates rotational speed of the wheel assembly 205, and can compute and predict the angular position of the bar 100 for any point in time during the immediately following revolution or revolutions. From the angular position and the constant longitudinal position of a particular LED 115 on the body 105 of the bar 100, the microcontroller 121 can compute the two dimensional position of the particular LED 115 for any point in time during the immediately following revolution(s).

Given the image data and the signal from the sensor 130 that allows the microcontroller 121 to determine positions of each LED 115, the microcontroller 121 computes the ON and OFF times for the LEDs that would create the desired image. The microcontroller 121 can thus appropriately drive (and, optionally, modulate, particularly in the case of multi-color image displays) the inputs to the LED driver 122 during the ON and OFF times of the corresponding LEDs 115, to create the image.

The program code executed by the microcontroller 121 may be stored in a ROM internal or external to the microcontroller 121. The code may be downloaded into the ROM of the control module 120 via a network, such as the Internet, from a programming tool, or another device. The code may be stored on a variety of machine readable media, for example, a CD, DVD, flash memory, floppy or hard drive, or a similar memory or storage device.

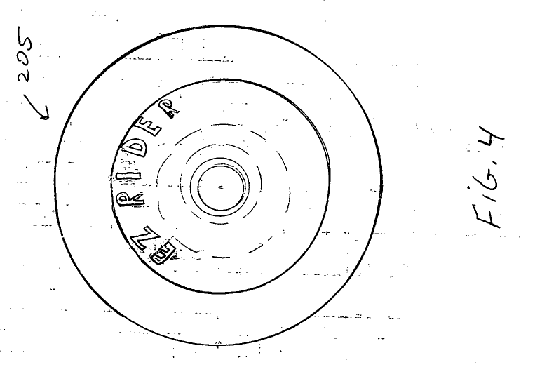

The variety of the images created by the light display bar 100 is practically endless, including text, graphics, and patterns. The images may be rendered in one color. In embodiments with multi-color light sources, the images may be rendered in multiple colors. The microcontroller 121 can cause the image to remain stationary, i.e., at a constant angle to the horizontal or vertical axis. To illustrate the stationary display capability, FIG. 4 shows the rotating wheel assembly 205 with the bar 100 displaying stationary text “EZ RIDER.” The microcontroller 121 can also allow the image to rotate at the rotational speed of the wheel assembly 205, or at a different speed. Indeed, the microcontroller 121 may rotate the image in the direction opposite to the rotation of the wheel assembly 205. Note that the invention is not limited to specific text, image, pattern, or sequence of patterns.

The light display bar 100 can thus generate and display various images when it is mounted on a rotating wheel assembly 205. The rotational speed or revolutions per minute of the wheel assembly 205 generally need to exceed some limit in order for a typical observer's eye to perceive the flashing LEDs 115 as an image, as opposed to simply a collection of rotating and flashing LEDs. The lower limit may be in the ten revolutions per minute range. To improve the quality of the perceived image, particularly at lower speeds, several strips of flashing LEDs (or other light sources) may be installed on the same wheel assembly. In some embodiments, two or more strips of LEDs are uniformly distributed on the wheel assembly. (Uniformly distributed means distributed in equal angular offsets from each other; each of four strips, for example, may be offset by 90 degrees from each of its neighboring strips.) The number of strips may be made equal to the number of wheel mounting bolts of the wheel assembly, so that each strip may be mounted on one of the bolts. The strips may be activated by a single control module.

A light display bar such as the bar 100 may be manufactured and marketed by itself. It may be advantageous, however, to build a light display device into a hubcap or into a wheel rim. Multiple light display bars, as described in the immediately preceding paragraph, may also be built into a hubcap or a wheel rim.

In accordance with another aspect of the invention, light display bars may be installed on (or built into) multiple wheel assemblies of the same vehicle. The images displayed on the multiple wheel assemblies may be coordinated. For example, related text messages may be displayed on the front and rear wheels of the same side of an automobile. The images may be coordinated by a remote control device that communicates with the light display bars via their respective communication modules. The multiple light display bars may also wirelessly coordinate their respective display images directly with each other using their communication modules. For example, related text may be displayed on wheels of the same vehicle.

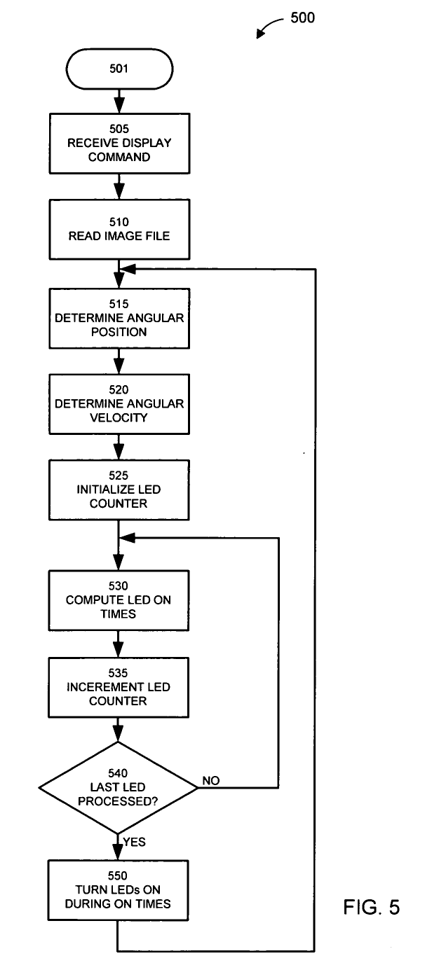

FIG. 5 illustrates selected steps of a method 500 for displaying an image on a rotating wheel assembly, in accordance with aspects of the present invention. Although certain steps are shown and described serially, some steps can be performed by separate elements in conjunction or in parallel, asynchronously or synchronously, in a pipelined manner, or otherwise. There is no particular requirement that the steps be performed in the same order in which this description lists them, except where explicitly so indicated, otherwise made clear from the context, or inherently required. Furthermore, not every illustrated step may be required in every embodiment in accordance with the invention, while some steps that have not been specifically illustrated may be desirable or necessary in some embodiments in accordance with the invention.

In step 505, a command to display an image is received. In step 510, an image file corresponding to the image is read. In step 515, angular position of a wheel assembly is determined at a particular time. In step 520, angular velocity (e.g., in RPM) of the wheel assembly is determined.

In step 525, an LED counter is initialized. In step 530, ON and OFF times for an LED corresponding to a current value of the LED counter are computed based on the data in the image file, the angular position of the wheel assembly at a particular time, current RPM of the wheel assembly, and the longitudinal position (distance from center of rotation) of the LED corresponding to the current value of the LED counter. Modulation values for the LEDs may also be computed at this time. In step 535, the LED counter is incremented.

In decision block 540, the value of the LED counter is tested against the counter value corresponding to the last LED. If LED ON and OFF times for the last LED have not been computed, process flow returns to the step 530. Otherwise, process flow advances to step 545 to turn the LEDs on during the ON times computed for each LED, and to turn the LEDs off during the off times computed for each LED. The LEDs may be driven to emit intensities corresponding to the modulation values computed as part of the step 530. Process flow then returns to the step 515 to update the angular position and angular velocity variables from sensor readings, e.g., from the signal generated by an angular position sensor. Process flow may terminate when, for example, a terminate display command is received from a remote control device over a wireless channel, directing the display apparatus to stop displaying the specific image. Process flow termination may be interrupt driven.

This document describes in considerable detail the inventive apparatus, methods, and articles of manufacture for displaying images, text, and patterns on rotating wheels. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth herein. Various physical arrangements of components and various step sequences also fall within the intended scope of the invention. Furthermore, the invention need not be limited to automobile wheel applications, but may also be used on bicycles, motorcycles, and other wheeled conveyances. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

I claim:

1. A method for displaying an image on a rotating object, the method comprising:
providing a plurality of light sources at varying distances from center of rotation of the rotating object;
determining angular position of the rotating object at a plurality of points in time;
determining angular velocity of the rotating object;
responsive to results of the steps of determining angular position and determining angular velocity, computing ON and OFF times for each light source of the plurality of light sources so as to create appearance of the image when the light sources are turned on during the ON times and the light sources are turned off during the OFF times;
turning the light sources on during the ON times; and
turning the light sources off during the OFF times.

2. The method of claim 1, wherein the step of determining angular position comprises reading output signal of an angular position sensor that indicates magnitude of a force exerted by a mass due to gravity and rotational acceleration.

3. The method of claim 1, wherein the step of determining angular position comprises reading output of a magnetic pick-up coil mounted on the rotating object, wherein the rotation of the rotating object moves the magnetic pick-up coil past a magnet.

4. The method of claim 1, wherein the step of determining angular velocity comprises determining a time period between sequential points in time when the rotating object is in a predetermined angular position and dividing the time period by number of revolutions of the rotating object during the time period.

5. The method of claim 1, wherein the rotating object is an automobile wheel assembly.

6. The method of claim 5, wherein the step of providing a plurality of light sources comprises providing a plurality of strips of light sources, each of the strips being positioned in a substantially radial direction on the automobile wheel assembly.

7. The method of claim 5, wherein the step of providing a plurality of light sources comprises providing a plurality of radially mounted light emitting diodes (LEDs).

8. The method of claim 7, wherein:
each LED of at least a subset of the plurality of LEDs is a multi-color LED; and
the step of computing ON and OFF times comprises computing the ON and OFF times for each color of each multi-color LED of the subset.

9. The method of claim 5, further comprising providing a generator capable of generating electrical energy for operation of the plurality of light sources from kinetic energy of the automobile wheel assembly.

10. The method of claim 5, further comprising providing a generator capable of generating electrical energy for operation of the plurality of light sources from movement of air in relation to the automobile wheel assembly.

11. The method of claim 5, further comprising receiving over a wireless communication channel a command to display the image, wherein the steps of turning the light sources on during the ON times and turning the light sources off during the OFF times are performed in response to receipt of the command to display the image.

12. The method of claim 11, further comprising sending the command from a remote control device located in a passenger compartment of an automobile.

13. The method of claim 11, wherein the command comprises selection of the image from a plurality of images.

14. The method of claim 5, wherein the step of computing ON and OFF times comprises computing the ON and OFF times in accordance with an image file corresponding to the image, the method further comprising receiving the file over a wireless communication channel.

15. The method of claim 5, wherein the step of providing a plurality of light sources comprises providing the plurality of light sources built-into a hubcap of the wheel assembly.

16. The method of claim 5, wherein the step of providing a plurality of light sources comprises providing the plurality of light sources built-into a rim of the wheel assembly.

17. The method of claim 5, wherein the step of providing a plurality of light sources comprises providing the plurality of light sources built-into a bar mountable on the wheel assembly.

18. Display apparatus comprising:
a plurality of light sources configured to be positioned at varying distances from center of rotation of a wheel assembly;
a first sensor that provides a signal that varies with rotation of the wheel assembly;
a control module coupled to the plurality of light sources and to the first sensor, the control module comprising a processor configured to:
receive the signal provided by the first sensor,
determine angular position of the rotating wheel assembly from the signal provided by the first sensor,
determine angular velocity of the rotating wheel assembly,
compute ON and OFF times for each light source of the plurality of light sources so as to create appearance of an image when the light sources are turned ON during the ON times and turned OFF during the OFF times,
turn the light sources on during the ON times, and
turn the light sources off during the OFF times.

19. The display apparatus of claim 18, wherein the signal provided by the first sensor indicates gravitational and centrifugal force acting on an element of the first sensor, the element being attached to the wheel assembly.

20. The display apparatus of claim 18, wherein the signal provided by the first sensor is output by a magnetic pick-up coil moved by the rotation of the rotating wheel assembly in proximity of a magnet.

21. The display apparatus of claim 18, wherein the processor determines the angular velocity by determining a time period between sequential points in time when the rotating wheel assembly is in a predetermined angular position, and dividing the time period by number of revolutions of the rotating wheel assembly during the time period.

22. The display apparatus of claim 18, wherein the light sources of the plurality of light sources are arranged along a plurality of substantially radial directions of the wheel assembly.

23. The display apparatus of claim 18, wherein the plurality of light sources comprises a plurality of light emitting diodes (LEDs) radially mounted on the wheel assembly.

24. The display apparatus of claim 23, wherein:
each LED of at least a subset of the plurality of LEDs is a multi-color LED; and
the processor computes the ON and OFF times for each color of each multi-color LED of the subset.

25. The display apparatus of claim 18, further comprising a generator capable of generating electrical energy for operation of the plurality of light sources from kinetic energy of the wheel assembly.

26. The display apparatus of claim 18, further comprising a generator capable of generating electrical energy for operation of the plurality of light sources from movement of the wheel assembly relative to air surrounding the wheel assembly.

27. The display apparatus of claim 18, further comprising:
a wireless communication module;
wherein:
the processor is further configured to receive through the wireless communication module a command to display the image; and
the processor turns the light sources on during the ON times and off during the OFF times in response to receipt of the command to display the image.

28. The display apparatus of claim 27, further comprising a remote control device capable of sending the command over a wireless communication channel.

29. The display apparatus of claim 27, wherein the command comprises selection of the image from a plurality of images, and the processor is further configured to identify the image from the command.

30. The display apparatus of claim 18, further comprising:
a wireless communication module;
wherein:
the processor is further configured to receive an image file corresponding to the image via the wireless communication module; and
the processor computes the ON and OFF times in accordance with the image file.

31. The display apparatus of claim 18, wherein the light sources of the plurality of light sources are built-into a hubcap of the wheel assembly.

32. The display apparatus of claim 18, wherein the light sources of the plurality of light sources are built-into a rim of the wheel assembly.

33. The display apparatus of claim 18, further comprising a body, the body comprising a first end and a second end, the first end comprising portions defining an aperture capable of receiving a wheel mounting bolt of the wheel assembly, the second end comprising portions defining an opening capable of receiving an air valve stem of the wheel assembly, wherein the opening and the aperture are positioned so that the body can be mounted on the wheel assembly with the bolt protruding through the aperture and the opening receiving the air valve stem, wherein the light sources of the plurality of light sources are distributed along a length of the body between the first and the second ends.
34. An article of manufacture comprising machine-readable medium storing program code, wherein the program code, when executed by one or more processors of a display apparatus comprising a plurality of light sources positioned at varying distances from center of rotation of a wheel assembly, a first sensor that provides a signal that varies with rotation of the wheel assembly, and a control module coupled to the plurality of light sources and to the first sensor, the control module comprising the one or more processors, configures the one or more processors to:
receive the signal provided by the first sensor,
determine angular position of the rotating wheel assembly from the signal provided by the first sensor,
determine angular velocity of the rotating wheel assembly,
compute ON and OFF times for each light source of the plurality of light sources so as to create appearance of an image when the light sources are turned on during the ON times and turned off during the OFF times,
turn the light sources on during the ON times, and
turn the light sources off during the OFF times.
